(19) United States
(12) Patent Application Publication
(10) Pub. No.: US 2014/0307463 A1
(43) Pub. Date: Oct. 16, 2014

(54) CASING FOR PORTABLE DEVICES

(71) Applicant: Yong Seung Paik, Hwaseong-si (KR)

(72) Inventor: Yong Seung Paik, Hwaseong-si (KR)

(21) Appl. No.: 14/180,263

(22) Filed: Feb. 13, 2014

(30) Foreign Application Priority Data
Apr. 15, 2013 (KR) 10-2013-0040828

(51) Int. Cl. F21V 8/00; F21V 33/00

(52) U.S. Cl. CPC G02B 6/0086; F21V 33/0052
USPC 362/602

(57) ABSTRACT

A portable device casing includes a light guiding plate and a cover. The light guiding plate is fitted over an outer surface of the portable device and has an opening through which a light source of the portable device is exposed to an outside of the light guiding plate. The light guiding plate receives light emitted from the light source and emits the light outwards. The cover is movable with respect to the opening of the light guiding plate. The portable device casing can safely protect a portable device from external impact. Further, the light guiding plate of the portable device casing emits light, thus satisfying the aesthetic sense of a user.

### CROSS-REFERENCE TO RELATED APPLICATION

This application claims priority to and the benefit of Korean Patent Application No. 10-2013-0040828, filed on Apr. 15, 2013, in the Korean Intellectual Property Office, the entire contents of which are incorporated herein by reference in their entirety.

### BACKGROUND

1. Field

The present invention relates to a casing for portable devices.

2. Description of the Related Art

As technology develops, various small portable devices in which different kinds of electronic components are integrated and reduced in size to facilitate carrying of such devices have been released. For example, there are folder type mobile phones, bar type mobile phones, slide type mobile phones, MP3 players, CD players, portable multimedia players (PMPs), personal digital assistants (PDAs), palms, portable small TVs, portable game machines, notebook computers, electronic dictionaries, distal cameras, navigation devices, GPS receivers, etc.

Recently, portable devices such as smartphones or smart pads which are combined with the functions of the above-mentioned portable devices are being released. Such portable devices are comparatively expensive. However, because design and convenience in carrying are very important factors of such portable devices, a housing is made of material that is light but not strong so as to reduce the size and weight of a terminal. Therefore, there is a problem in that the terminal is easily damaged or scratched by external impact.

To solve the above problem and appropriately decorate the appearance of such a portable device depending on preference of a user, the portable device is covered with a separate portable device casing which is comparatively strong. Thereby, the housing of the portable device can be protected from external impact, the user can express his/her individuality, and good appearance can be provided.

### SUMMARY

Accordingly, the present invention has been made keeping in mind the above problems occurring in the prior art, and an aspect of the present invention is to provide a casing for portable devices which can reliably protect a portable device from external impact and satisfy the aesthetic sense of a user.

In order to accomplish the above aspect, the present invention provides a casing for a portable device, including: a light guiding plate fitted over an outer surface of the portable device and having an opening through which a light source of the portable device is exposed to an outside of the light guiding plate, the light guiding plate being configured to receive light emitted from the light source and to emit the light outwards; and a cover that is movable with respect to the opening of the light guiding plate.

The cover may move between a first position at which the cover covers the light source that is exposed to the outside through the opening and a second position at which the cover opens the light source.

When the cover is disposed at the first position, some of the light emitted from the light source may be reflected by the cover and transmitted to the light guiding plate.

When the cover is disposed at the first position, the cover may cover a camera unit of the portable device which is disposed adjacent to the light source.

The light guiding plate may include: a first light guiding part disposed on a first surface of the portable device in which the light source is positioned; and a second light guiding part disposed on a second surface of the portable device that is adjacent to the first surface, the second light guiding part being connected to the first light guiding part.

The cover may cover an entirety of the first light guiding part when the cover is at the first position.

The first light guiding part may have a first area in which the opening is formed, and a second area that is a remnant area other than the first area.

The cover may cover the first area when the cover is at the first position.

The casing may further include a shield plate disposed on the second area of the first light guiding part.

The opening may be configured to have an inclined shape in such a way that a diameter thereof is reduced from a first end thereof adjacent to the light source to a second end thereof far from the light source.

Some of the light emitted from the light source may be transmitted to the light guiding plate through an inclined surface of the opening.

The light guiding plate may be transparent or semi-transparent, and the cover may be opaque.

A rail may be provided on the light guiding plate, and the cover may be provided so as to be slidable along the rail with respect to the opening of the light guiding plate.

The light guiding plate and the cover may be spaced apart from each other to form a space therebetween.

The light guiding plate may include a reflector reflecting light emitted from the light source, wherein the reflector may reflect the light towards an upper surface of the light guiding plate.

The light guiding plate may have a camera exposure hole through which a camera unit of the portable device is exposed to the outside.

The camera exposure hole and the opening may communicate with each other.

The casing may further include a light guiding film provided between the light guiding plate and the portable device.

The light guiding film may receive light from the light source and express a pattern.

The light guiding film may have an opening through which the light source is exposed to the outside.

### BRIEF DESCRIPTION OF THE DRAWINGS

The above and other aspects and features of the present invention will be more clearly understood from the following detailed description taken in conjunction with the accompanying drawings, in which:

FIG. 1 is a perspective view of a portable device covered with a portable device casing according to an embodiment of the present invention;

FIG. 2 is a perspective view showing the state of the portable device casing of FIG. 1 when a cover of the casing opens a light source;

FIG. 3 is a sectional view taken along line A-A′ of FIG. 1;

FIG. 4 is a sectional view taken along line B-B′ of FIG. 1;

FIG. 5 is a sectional view showing a modification example of FIG. 4;

FIG. 6 is a perspective view of a portable device covered with a portable device casing according to another embodiment of the present invention;

FIG. 7 is a perspective view showing the state of the portable device casing of FIG. 6 when a cover of the casing opens the light source;

FIG. 8 is a sectional view taken along line C-C′ of FIG. 6;

FIG. 9 is a perspective view of a portable device covered with a portable device casing according to a further embodiment of the present invention;

FIG. 10 is a sectional view taken along line D-D′ of FIG. 9;

FIG. 11 is a perspective view showing the state of the portable device casing of FIG. 9 when a cover of the casing opens the light source;

FIG. 12 is a sectional view taken along line E-E′ of FIG. 11;

FIG. 13 is a perspective view of a portable device covered with a portable device casing according to yet another embodiment of the present invention;

FIG. 14 is an exploded perspective view showing the portable device casing and the portable device of FIG. 13; and

FIG. 15 is a sectional view of a light guiding film of the portable device casing, taken along line F-F′ of FIG. 14.

### DETAILED DESCRIPTION

Hereinafter, preferred embodiments of the present invention will be described in detail with reference to the attached drawings. Reference now should be made to the drawings, in which the same reference numerals are used throughout the different drawings to designate the same or similar components. If in the specification, detailed descriptions of well-known functions or configurations would unnecessarily obfuscate the gist of the present invention, the detailed descriptions will be omitted.

The terms and words used in the specification and claims must not be limited to typical or dictionary meanings, but must be regarded as concepts selected by the inventor as concepts which best illustrate the present invention, and must be interpreted as having meanings and concepts adapted to the scope and spirit of the present invention to aid in understanding the technology of the present invention.

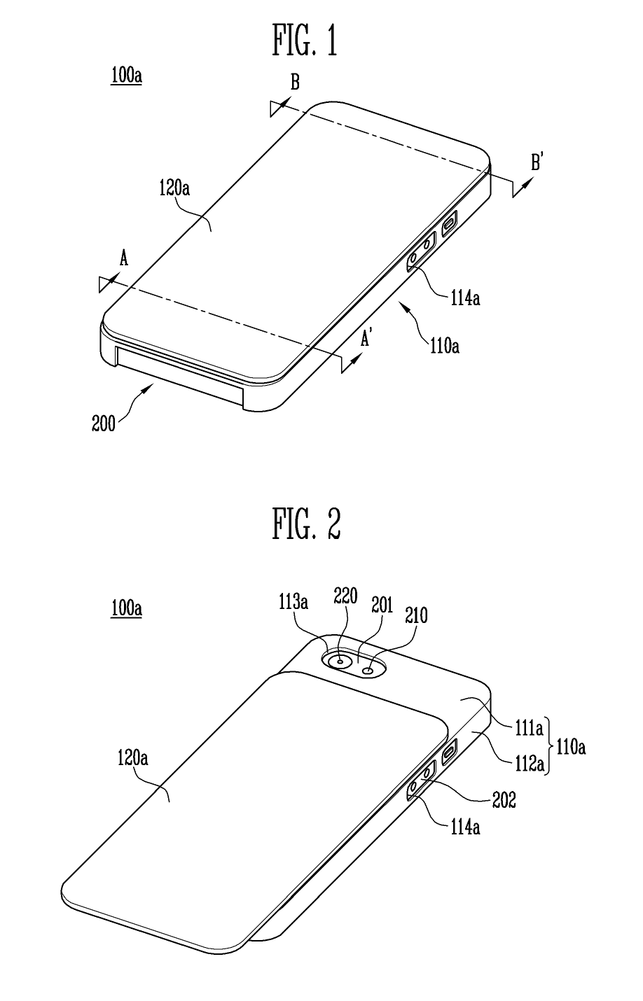

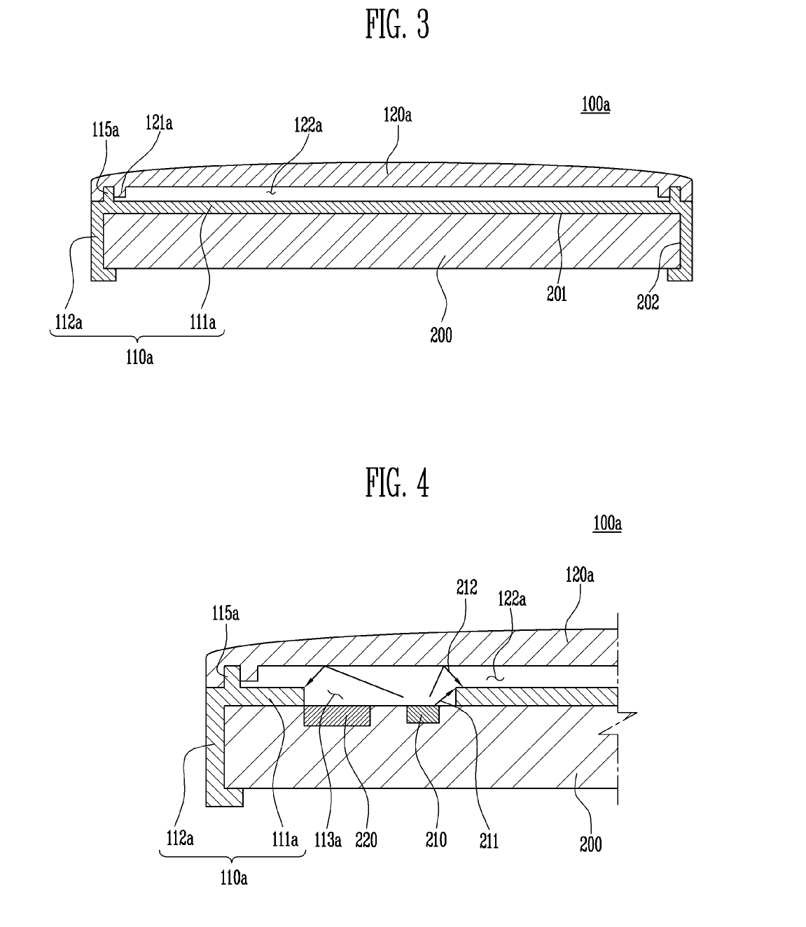

FIG. 1 is a perspective view of a portable device 200 covered with a portable device casing 100a according to an embodiment of the present invention. FIG. 2 is a perspective view showing the state of the portable device casing 100a of FIG. 1 when a cover 120a of the casing opens a light source 210. FIG. 3 is a sectional view taken along line A-A′ of FIG. 1. Hereinafter, the portable device casing 100a according to the embodiment of the present invention will be described in detail with reference to the drawings.

As shown in FIGS. 1 and 2, the portable device casing 100a according to the embodiment of the present invention includes a light guiding plate 110a which receives light emitted from the light source 210 of the portable device 200 and emits the light out of the casing 100a, and the cover 120a which is provided so as to be movable (e.g., slidable) with respect to an opening 113a of the light guiding plate 110a.

The light guiding plate 110a is a base part of the portable device casing 100a and is fitted over an outer surface of the portable device 200.

The light guiding plate 110a is configured such that it covers both a first surface 201 of the portable device 200 in which the light source 210 is disposed and a second surface 202 which is adjacent to the second surface 202. In other words, the light guiding plate 110a covers a rear surface and a side surface of the portable device 200, for example, a smartphone. The light guiding plate 110a includes a first light guiding part 111a which is disposed on the first surface 201 of the portable device 200, and a second light guiding part 112a which is disposed on the second surface 202. The opening 113a is formed in the first light guiding part 111a so that the light source 210 is exposed to the outside through the opening 113a. Here, the opening 113a may have a sufficiently large size so that a camera unit 220 of the portable device 200 can also be exposed to the outside. Furthermore, a button hole 114a may be formed in the second light guiding part 112a so that a volume button, a functional button, etc. of the portable device 200 can be exposed to the outside through the button hole 114a.

Given the fact that the light guiding plate 110a receives light from the light source 210 of the portable device 200 and emits the light outwards, the light guiding plate 110a is made of transparent or semi-transparent material. Preferably, the light guiding plate 110a is made of material which can effectively transmit light. Furthermore, the light guiding plate 110a is made of material having comparatively high rigidity so as to reliably protect the portable device 200 from external impact.

The cover 120a is provided so as to be movable (e.g., slidable) with respect to the opening 113a of the light guiding plate 110a, thus covering or opening the light source 210. The term ‘covering the light source 210’ means that a user cannot see the light source 210. The term ‘opening the light source 210’ means that the user can see the light source 210.

The cover 120a can move (e.g., slide) with respect to the light guiding plate 110a between a first position of FIG. 1 and a second position of FIG. 2. As shown in FIG. 3, for example, rails 115a are provided on the first light guiding part 111a of the light guiding plate 110a that corresponds to the first surface 201 of the portable device 200. The cover 120a can move (e.g., slide) along the rails 115a. For this, guides 121a are provided on the cover 120a at positions corresponding to the respective rails 115a. The guides 121a engage with the corresponding rails 115a and thus guide the movement (e.g., sliding movement) of the cover 120a. An empty space 122a that has a height corresponding to that of the rails 115a is formed between the cover 120a and the first light guiding part 111a. A credit card, a transportation card or the like can be stored in the empty space 122a. Thereby, convenience for the user can be improved. Two stoppers are provided on the cover 120a so that when the cover 120a is at the first position (the position of FIG. 1), the rails 115a are blocked by the stoppers, thus preventing the cover 120a from being excessively moved upwards from a correct position relative to the light guiding plate 110a after covering the light source 210. In addition, the stoppers functions to prevent the cover 120a from being further moved downwards from the second position of FIG. 2.

Meanwhile, when the cover 120a is disposed at the first position of FIG. 1, the light source 210 is covered with the cover 120a. When the cover 120a is disposed at the first position of FIG. 2, the light source 210 can be exposed to the outside. Therefore, the user usually disposes the cover 120a at the first position. When it is required to use the light source 210 as a flash for the camera unit 220 or a typical flashlight, the user can move the cover 120a to the second position. Generally, time for which the light source 210 is not used is longer than time for which the light source 210 is used, and there are times when the portable device 200 is put in a pocket or a handbag while the light source 210 is not in use. In this case of the portable device casing 100a of the present invention, because the cover 120a covers the light source 210 at normal times, the light source 210 can be prevented from being scratched or damaged. Moreover, when the cover 120a is at the first position, the camera unit 220 which is disposed adjacent to the light source 210 can also be protected by the cover 120a. The camera unit 220 is opened, when the cover 120a is moved to the second position.

Preferably, the cover 120a has a size corresponding to that of the first light guiding part 111a so that the cover 120a can cover the entirety of the first light guiding part 111a when the cover 120a is at the first position. Unlike the light guiding plate 110a, the cover 120a is made of opaque material. The present invention is not limited to the above-described structure, and the cover 120a may cover, for example, only portion of the first light guiding part 111a. In this case, the user can see light emitting from the first light guiding part 111a.

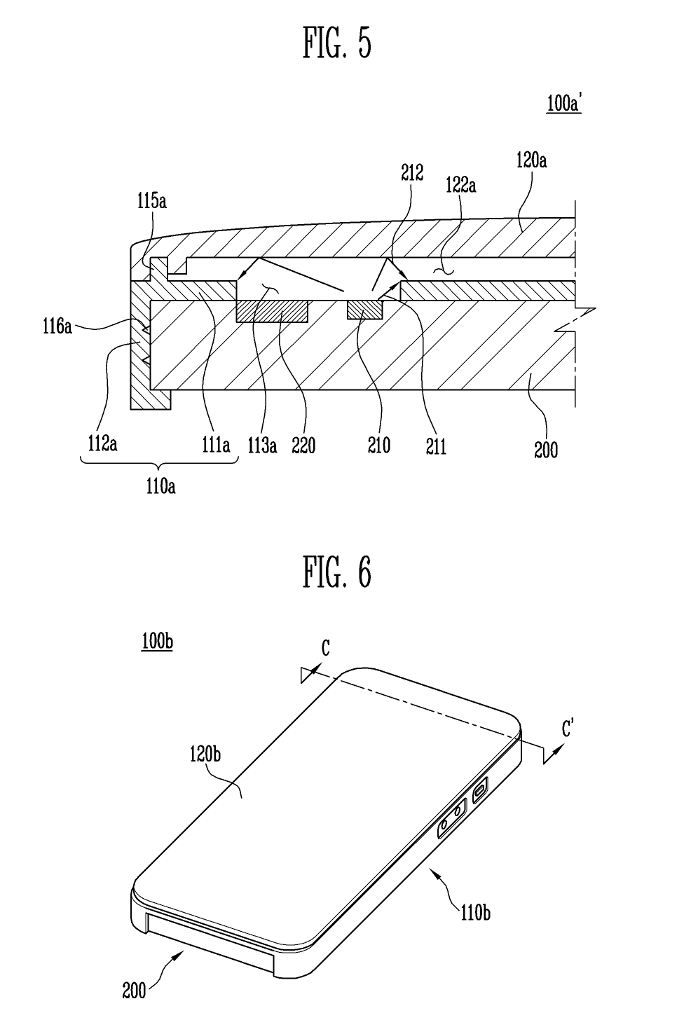

FIG. 4 is a sectional view taken along line B-B′ of FIG. 1. FIG. 5 is a sectional view showing a modification example of FIG. 4. Hereinafter, a light transmission process of the portable device casing 100a, 100a′ according to the present invention will be explained with reference to FIGS. 4 and 5.

As shown in FIG. 4, other than when the user uses the light source 210 as a flash for the camera unit 220 or a typical flashlight, in other words, even when the cover 120a is at the first position shown in FIG. 1, the light source 210 may be in a turned-on state. For instance, the turned-on state of the light source 210 can be controlled by an application or environment setting of the portable device 200.

Meanwhile, as shown in FIG. 4, light emitted from the light source 210 passes through the opening 113a. For example, an LED can be used as the light source 210, and a light emitting angle of the LED may be 120°. Some light 211 emitted from the light source 210 is directly transmitted to the first light guiding part 111a, and the other light 212 passes through the opening 113a and reaches the cover 120a. The light 212 that reaches the cover 120a is reflected by the cover 120a and then transmitted to the first light guiding part 111a. Light that has been transmitted to the first light guiding part 111a is transmitted to the second light guiding part 112a through the first light guiding part 111a. Thereby, when seen from the outside, the portable device casing may be seen as if only the second light guiding part 112a emits light because the first light guiding part 111a is covered with the cover 120a. Therefore, the peripheral portion of the portable device casing 100a seems to emit light, thus making the appearance of the portable device casing 100a beautiful. Furthermore, the portable device 200 can be controlled such that the light source 210 flickers on and off. In this case, the second light guiding part 112a can also seem to flicker on and off.

To make the appearance of the portable device casing 100a more splendid, as shown in FIG. 5, reflectors 116a may be provided on the second light guiding part 112a of the portable device casing 100a′. Light is reflected by the reflectors 116a and then emitted out of the outer surface of the second light guiding part 112a. Thus, a portion on which the reflectors 116a are disposed can shine more brightly. For example, a pattern such as a letter or a sign may be indicated. Furthermore, a light guiding path may be defined in the first light guiding part 111a or the second light guiding part 112a so that light is transmitted through the light guiding path. In this case, the portable device casing 100a may be configured such that only a desired portion shines more brightly. Also, light can be reliably transmitted to a portion that is comparatively disposed far from the light source 210. While the present invention is described primarily in reference to embodiments in which the cover 120a slidably moves, but the present invention is not limited thereto. For example, in various other embodiments, the cover may be moved in a linear direction, a rotational direction, or any other suitable direction with respect to the light guiding plate (e.g., with respect to the opening of the light guiding plate).

Meanwhile, in this state, as shown in FIG. 2, when the user moves (e.g., slides) the cover 120a, the light source 210 opens. Then, most light emitted from the light source 210 is emitted out of the portable device casing. Of course, even when the light source 210 opens, some light may be directly transmitted to the first light guiding part 111a before being transmitted to the second light guiding part 112a through the first light guiding part 111a. Nonetheless, the intensity of light emitted from the second light guiding part 112a when the light source 210 opens is less than that of the case where the light source 210 is covered with the cover 120a.

To increase the light transmission efficiency, a separate light guiding film may be provided between the light guiding plate 110a and the portable device 200.

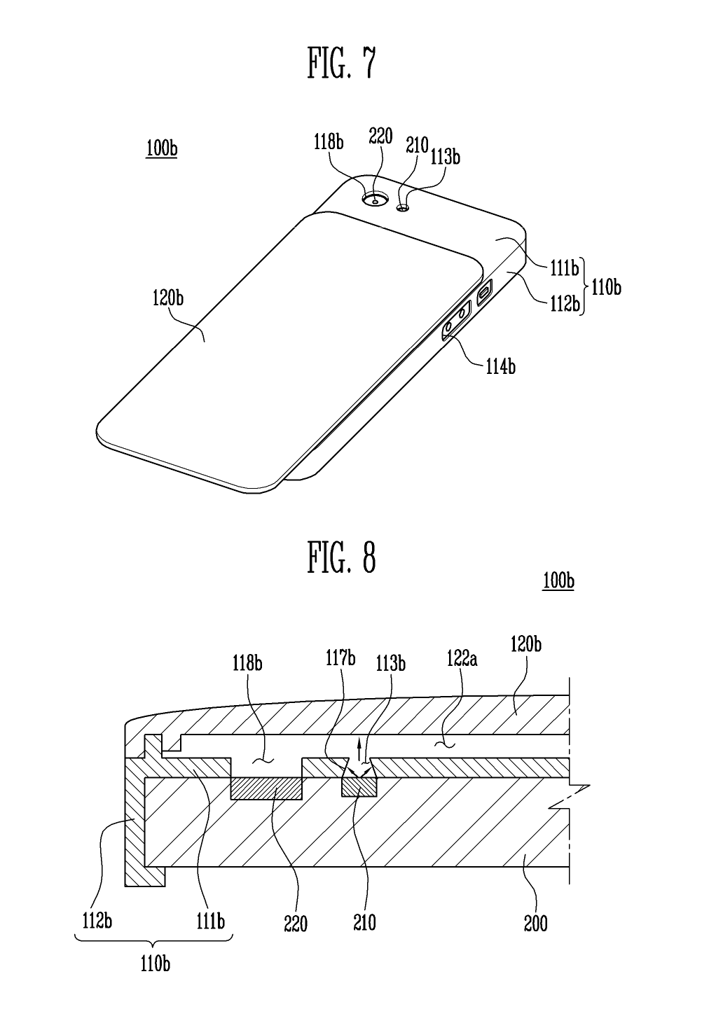

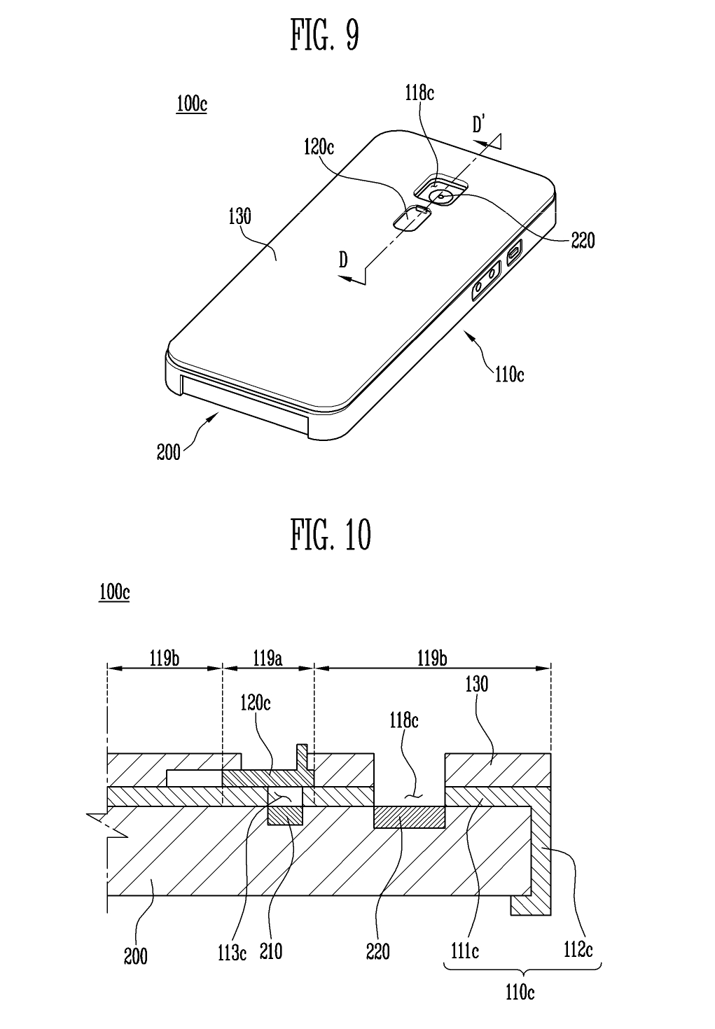

FIG. 6 is a perspective view of a portable device 200 covered with a portable device casing 100b according to another embodiment of the present invention. FIG. 7 is a perspective view showing the state of the portable device casing 100b of FIG. 6 when a cover 120b of the casing 100b opens the light source 210. FIG. 8 is a sectional view taken along line C-C′ of FIG. 6. Hereafter, the portable device casing 100b according to this embodiment of the present invention will be described with reference to these drawings.

As shown in FIGS. 6 through 8, the portable device casing 100b according to this embodiment of the present invention includes a light guiding plate 110b which receives light emitted from the light source 210 of the portable device 200 and emits the light out of the casing 100b, and the cover 120b which is provided so as to be movable (e.g., slidable) with respect to an opening 113b of the light guiding plate 110b. In this embodiment, the opening 113b is configured to have an inclined shape in such a way that the diameter thereof is reduced from an end thereof adjacent to the light source 210 to the other end thereof far from the light source 210.

That is, in this embodiment, the nearer the light source 210, the larger the diameter of the opening 113b. The farther the light source 2120, the smaller the diameter of the opening 113b. In this case, some light emitted from the light source 210 can be more easily transmitted to the light guiding plate 110b (refer to FIG. 8). In detail, for example, the light source 210 such as an LED emits light with a light emitting angle range of 120°. Light that is within a range from 90° to 120° is directly transmitted to the first light guiding part 111b through an inclined surface 117b of the opening 113b. That is, in the preceding embodiment, only light which is within a range from about 110° to 120° is directly transmitted to the light guiding plate 110a, but in this embodiment, light which is within a range from 90° to 120° can also be directly transmitted to the light guiding plate 110b. Therefore, the intensity of light emitted from the second light guiding part 112b can be increased compared to that of the preceding embodiment. As a result, when seen from the outside, the second light guiding part 112b seems to shine more brightly, thus making the appearance of the portable device casing 100b more beautiful.

Meanwhile, in this embodiment, the camera unit 220 can be exposed to the outside through a camera exposure hole 118b. The exposure hole 118b is disposed at a position spaced apart from the opening 113b by a predetermined distance. The present invention is not limited to this. For example, the exposure hole 118b and the opening 113b may be formed in such a way that they communicate with each other. Further, although, in FIG. 8, a diameter of the portion of the opening 113b that makes contact with the light source 210 has been illustrated as being the same as that of the light source 210, this is only exemplary, and the diameter may be formed smaller so that a larger amount of light enters the light guiding plate 110b, or it may be formed larger.

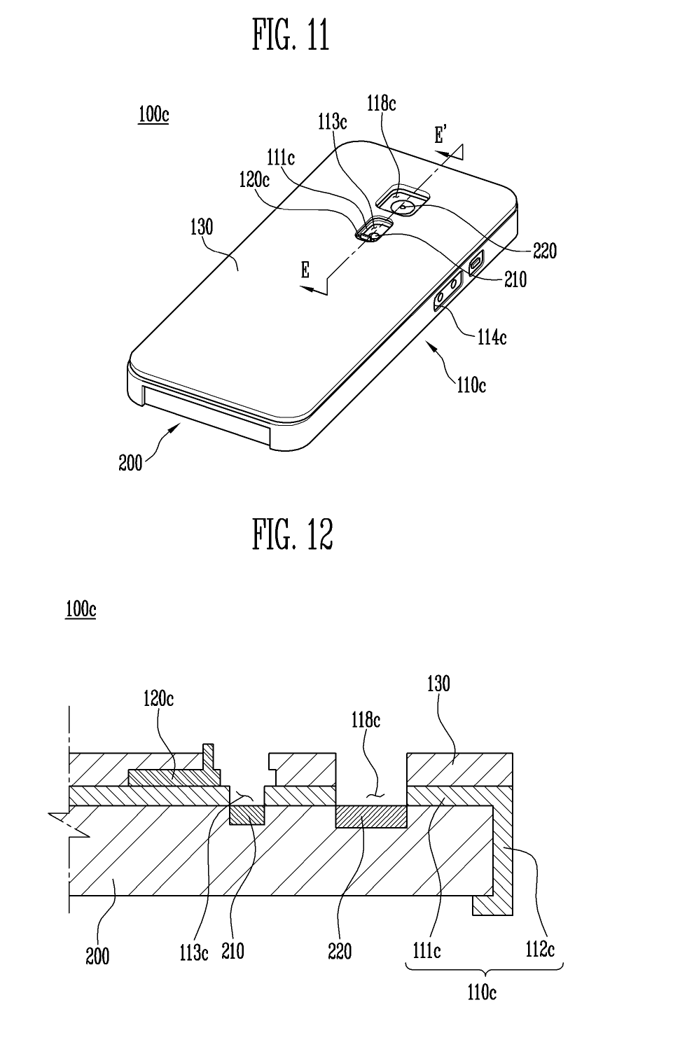

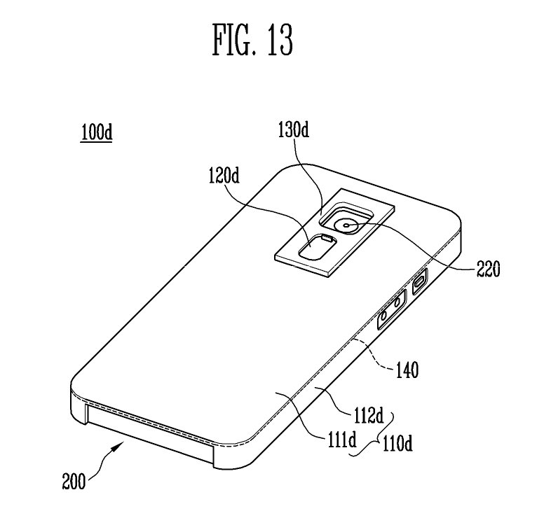

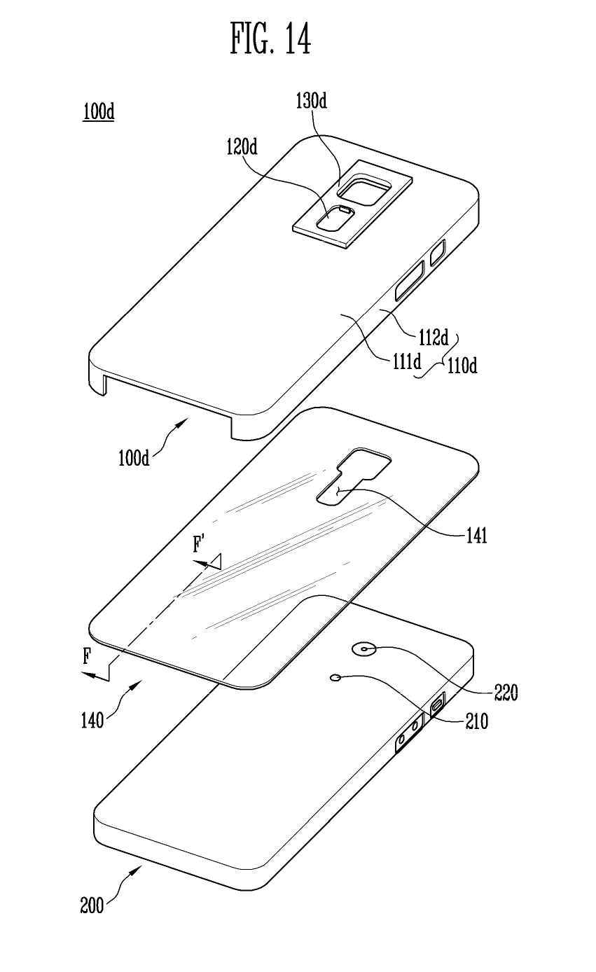

FIG. 9 is a perspective view of a portable device 200 covered with a portable device casing 100c according to a further embodiment of the present invention. FIG. 10 is a sectional view taken along line D-D′ of FIG. 9. FIG. 11 is a perspective view showing the state of the portable device casing 100c of FIG. 9 when a cover 120c of the casing 100c opens the light source 210. FIG. 12 is a sectional view taken along line E-E′ of FIG. 11. Hereinafter, the portable device casing 100c according to this embodiment of the present invention will be described with reference to these drawings.

As shown in FIGS. 9 through 12, the portable device casing 100c according to this embodiment of the present invention includes a light guiding plate 110c which receives light emitted from the light source 210 of the portable device 200 and emits the light out of the casing 100c, and a cover 120c which is provided so as to be movable (e.g., slidable) with respect to an opening 113c of the light guiding plate 110c. The cover 120c covers only a first area 119a which is an area around an opening 113c, and a shield plate 130 is provided on a second area 119b (refer to FIG. 10).

In this embodiment, as shown in FIG. 10, the first light guiding part 111c is classified into a first area 119a and a second area 119b.

The first area 119a is an opening surrounding area including the opening 113c. The second area 119b is a remnant area of the first light guiding part 111c other than the first area 119a. The cover 120c is disposed on the first area 119a so as to be movable (e.g., slidable) with respect to the opening 113c. The shield plate 130 is disposed on the second area 119b. That is, in the embodiment, as shown in FIG. 9, the cover 120c covers only a portion (the first area 119a) of the first light guiding part 111c rather than covering the entirety of the first light guiding part 111c, when the cover 120c is at the first position. The shield plate 130 is disposed on the portion of the first light guiding part 111c that is not covered with the cover 120c. The shield plate 130 is made of opaque material in the same manner as that of the cover 120c so that when seen from the outside, only the second light guiding part 112c seems to emit light. However, the shield plate 130 may cover the entirety of an area of the first light guiding part 111c that is not covered with the cover 120c. Alternatively, the shield plate 130 may cover only a portion of the first light guiding part 111c which is around the cover 120c. Here, if the shield plate 130 covers a portion of the first light guiding part 111c, the user can also see light emitting from the first light guiding part 111c. Furthermore, the shield plate 130 may be made of semitransparent or transparent material. In addition, a pattern or the like may be expressed in such a way that semitransparent or transparent portions are formed in the shield plate 130.

Furthermore, not only the opening 113c but also a camera exposure hole 118c is formed in the first light guiding part 111c so that the camera unit 220 of the portable device 200 is exposed to the outside through the camera exposure hole 118c. As shown in FIG. 10, the opening 113c and the camera exposure hole 118c may be separately provided at positions spaced apart from each other or, alternatively, they may communicate with each other to form a single hole.

As shown in FIGS. 11 and 12, the cover 120c can move (e.g., slide) with respect to the opening 113c. When the cover 120c moves (e.g., slides) from the first position (the position of FIGS. 9 and 10) to the second position (the position of FIGS. 11 and 12), the light source 210 which is exposed to the outside through the opening 113c can open. Then, the user can appropriately use the light source 210 where required.

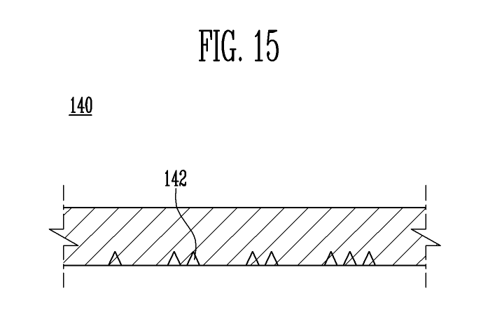

FIG. 13 is a perspective view of a portable device 200 covered with a portable device casing 100d according to yet another embodiment of the present invention. FIG. 14 is an exploded perspective view showing the portable device casing 100d and the portable device 200 of FIG. 13. FIG. 15 is a sectional view of a light guiding film 140 of the portable device casing 100d, taken along line F-F′ of FIG. 14. Hereinafter, the portable device casing 100d according to this embodiment of the present invention will be described.

As stated above, the separate light guiding film 140 may be provided between a light guiding plate 110d and the portable device 200. An opening 141 is formed in the light guiding film 140 to allow the light source 210 of the portable device 200 to be exposed to the outside. A separate camera exposure hole may be formed in the light guiding film 140, or the opening 141 may have a sufficiently large size so that the camera unit 220 of the portable device 200 can also be exposed to the outside. The light guiding film 140, along with the light guiding plate 110d, receives the light source and allows light to be emitted out of the casing 100d through the light guiding plate 110d. As such, both the light guiding film 140 and the light guiding plate 110d guide light out of the casing 100d, whereby the light guiding effect can be maximized.

As shown in FIG. 14, for example, the light guiding film 140 is disposed between the portable device 200 and a first light guiding part 111d of the light guiding plate 110d. A reflector 142 may be formed in the light guiding film 140 so that when light is transmitted from the light source 210 to the light guiding film 140, a pattern such as a letter or a sign can be expressed. Furthermore, a cover 120d may cover only a portion of the first light guiding part 111d that is around the light source 210 to allow the user to observe the pattern of the light guiding film 140 through the transparent or semitransparent first light guiding part 111d. In addition, a reflector may also be formed in the light guiding plate 110d so that when light is transmitted from the light source 210 to the casing 100d, the user can see not only the pattern formed in the light guiding film 140 but also the pattern formed in the light guiding plate 110d. Further, the light guiding film 140 may be disposed between a second light guiding part 112d and the portable device 200.

Meanwhile, as illustrated in this embodiment, if the separate light guiding film 140 is present, the user can more easily decorate the portable device casing 100d. For instance, if the user has various kinds of light guiding films 140 having different patterns, it is possible for the user to variously change the pattern of the portable device casing 100d merely by replacing the light guiding film 140 with another one. Compared to replacement of the light guiding plate 110d with another one, the replacement of the light guiding film 140 is inexpensive and simple, thus being more convenient for the user. In addition, a shield plate 130d may be formed around the opening of the first light guiding plate 110d or, alternatively, may be formed on the entire area of the first light guiding plate 110d other than the cover 120d.

As described above, a casing for portable devices according to the present invention can safely protect a portable device from external impact. Further, a light guiding plate of the portable device casing emits light, thus satisfying the aesthetic sense of a user.

Moreover, in the present invention, a cover is provided so as to be movable (e.g., slidable) with respect to an opening of the light guiding plate. Thus, when a light source is not in use, the cover can be selectively positioned at a first position to prevent the light source from being damaged.

Although the preferred embodiments of the present invention have been disclosed for illustrative purposes, the portable device casing according to the present invention is not limited to the embodiments, and those skilled in the art will appreciate that various modifications, additions and substitutions are possible within the scope of the present invention.

Such modifications, additions and substitutions fall within the scope and spirit of the present invention, and the bounds of the present invention must be defined by the accompanying claims.

What is claimed is:

1. A casing for a portable device, comprising:
a light guiding plate fitted over an outer surface of the portable device and having an opening through which a light source of the portable device is exposed to an outside of the light guiding plate, the light guiding plate being configured to receive light emitted from the light source and to emit the light outwards; and
a cover that is movable with respect to the opening of the light guiding plate.

2. The casing as set forth in claim 1, wherein the cover moves between a first position at which the cover covers the light source that is exposed to the outside through the opening and a second position at which the cover opens the light source.

3. The casing as set forth in claim 2, wherein when the cover is disposed at the first position, some of the light emitted from the light source is reflected by the cover and transmitted to the light guiding plate.

4. The casing as set forth in claim 2, wherein when the cover is disposed at the first position, the cover covers a camera unit of the portable device, the camera unit being disposed adjacent to the light source.

5. The casing as set forth in claim 2, wherein the light guiding plate comprises:
a first light guiding part disposed on a first surface of the portable device in which the light source is positioned; and
a second light guiding part disposed on a second surface of the portable device that is adjacent to the first surface, the second light guiding part being connected to the first light guiding part.

6. The casing as set forth in claim 5, wherein the cover covers an entirety of the first light guiding part when the cover is at the first position.

7. The casing as set forth in claim 5, wherein the first light guiding part has a first area in which the opening is formed, and a second area that is a remnant area other than the first area.

8. The casing as set forth in claim 7, wherein the cover covers the first area when the cover is at the first position.

9. The casing as set forth in claim 8, further comprising:
a shield plate disposed on the second area of the first light guiding part.

10. The casing as set forth in claim 1, wherein the opening is configured to have an inclined shape in such a way that a diameter thereof is reduced from a first end thereof adjacent to the light source to a second end thereof far from the light source.

11. The casing as set forth in claim 10, wherein some of the light emitted from the light source is transmitted to the light guiding plate through an inclined surface of the opening.

12. The casing as set forth in claim 1, wherein the light guiding plate is transparent or semi-transparent, and the cover is opaque.

13. The casing as set forth in claim 1, wherein a rail is provided on the light guiding plate, and
the cover is provided so as to be slidable along the rail with respect to the opening of the light guiding plate.

14. The casing as set forth in claim 13, wherein the light guiding plate and the cover are spaced apart from each other to form a space therebetween.

15. The casing as set forth in claim 1, wherein the light guiding plate comprises a reflector reflecting light emitted from the light source,
wherein the reflector reflects the light towards an upper surface of the light guiding plate.

16. The casing as set forth in claim 1, wherein the light guiding plate has a camera exposure hole through which a camera unit of the portable device is exposed to the outside.

17. The casing as set forth in claim 16, wherein the camera exposure hole and the opening communicate with each other.

18. The casing as set forth in claim 1, further comprising:
a light guiding film provided between the light guiding plate and the portable device.

19. The casing as set forth in claim 18, wherein the light guiding film receives light from the light source and expresses a pattern.

20. The casing as set forth in claim 18, wherein the light guiding film has an opening through which the light source is exposed to the outside.
